(19) United States
(12) Patent Application Publication
(10) Pub. No.: US 2005/0180147 A1
(43) Pub. Date: Aug. 18, 2005

(54) Light holder with trigger clip

(76) Inventors: Jared Hendricks, Draper, UT (US); Erik Bornemeier, Bountiful, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/049,307

(22) Filed: Feb. 2, 2005

Related U.S. Application Data
(60) Provisional application No. 60/543,486, filed on Feb. 4, 2004.

(51) Int. Cl. F21V 21/00

(52) U.S. Cl. 362/396; 362/654

(57) ABSTRACT

The present invention relates to an improved light holder. The light holder may be used individually or in series as part of a light string. The light holder includes a trigger clip that allows for one handed attachment to a rain gutter or other structure. The trigger clip mechanism is coupled to the body of the light holder. The trigger clip is configured to expand and clamp down on a gutter or structure effectively releasably coupling the light holder thereto. The trigger clip further includes a clip portion and a finger rest.

### RELATED APPLICATIONS

This application claims priority to U.S. provisional application Ser. No. 60/543,486, filed Feb. 4, 2004.

### BACKGROUND

1. Field of the Invention

The present invention relates to a light bulb holder. More particularly, the present invention relates to a light bulb holder configured for releasably coupling to surfaces and objects.

2. Background of the Invention and Related Art

Decorative lights are commonly attached to structures to provide light and attract attention. During the winter holiday season, it is customary to attache strings of lights to residential and commercial buildings. These strings of lights are essentially light holders coupled in series to provide electricity to each light holder. Each light holder is configured to mechanically and electrically receive a particularly sized light bulb. The light bulbs may be white or colored depending on the application. In addition, various electrical devices can be used to create lighting effects including blinking, strobing, flashing etc.

One of the problems associated with lighting decoration is the need to suspend the lights from a particular location such that they can be seen. On residential structures, this often involves attaching strings of lights to a rain gutter or some similar structure located on the front of the residence. Conventional attachment systems require that a user use two hands in order to couple each light holder to a rain gutter or structure. Because a user is often balanced precariously on a ladder, the necessity of a two handed attachment is both inconvenient and dangerous.

Therefore, there is a need in the industry for an improved light holder that does not require two hands for installation and provides users with an efficient attachment mechanism.

### SUMMARY OF THE INVENTION

The present invention relates to an improved light holder. The light holder may be used individually or in series as part of a light string. The light holder includes a trigger clip that allows for one handed attachment to a rain gutter or other structure. The trigger clip mechanism is coupled to the body of the light holder. The trigger clip is configured to expand and clamp down on a gutter or structure effectively releasably coupling the light holder thereto. The trigger clip further includes a clip portion and a finger rest.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1A illustrates a top view of a light holder in accordance with one embodiment of the present invention;

FIG. 1B illustrates a perspective view of the light holder illustrated in FIG. 1A;

FIG. 1C illustrates a rear view of the light holder illustrated in FIG. 1A; and

FIG. 1D illustrates a profile view of the light holder illustrated in FIG. 1A.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to an improved light holder. The light holder may be used individually or in series as part of a light string. The light holder includes a trigger clip that allows for one handed attachment to a rain gutter or other structure. The trigger clip mechanism is coupled to the body of the light holder. The trigger clip is configured to expand and clamp down on a gutter or structure effectively releasably coupling the light holder thereto. The trigger clip further includes a clip portion and a finger rest. While embodiments of the present invention are directed at methods of acquiring advertising data and optimizing advertisements, it will be appreciated that the teachings of the present invention are applicable to other areas.

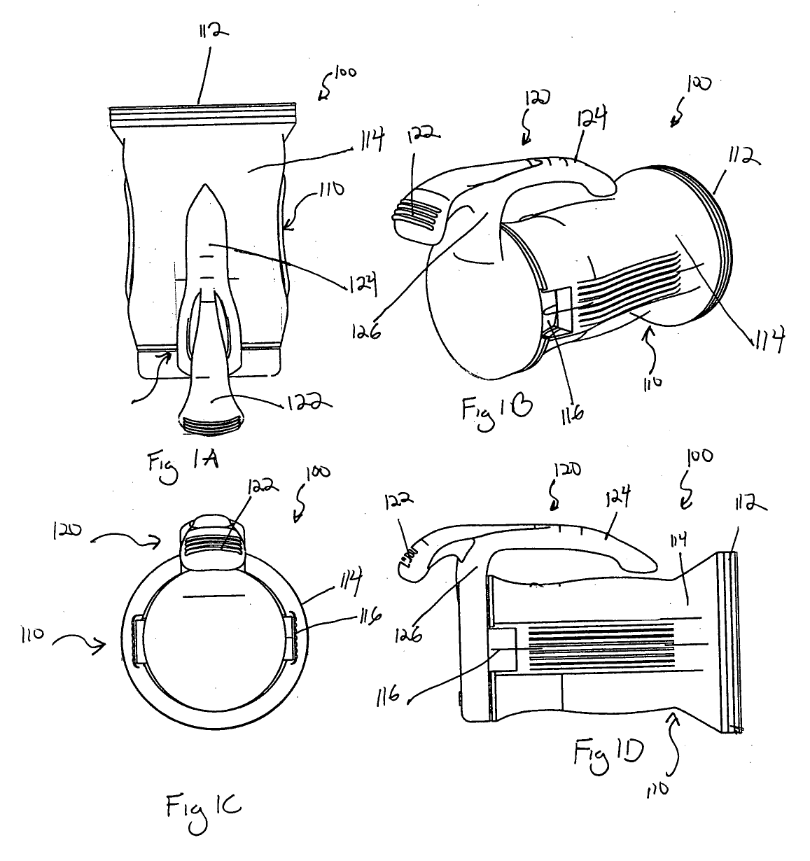

Reference is initially made to FIGS. 1A-1D, which illustrates various views of a light holder in accordance with one embodiment of the present invention. The light holder is designated generally at 100. The light holder 100 further includes a base 110 and a trigger clip 120. The base 110 includes a front flange 112, a body 114, and two wire recesses 116. The trigger clip 120 further includes a finger rest 122, a clip portion 124, and an attachment member 126.

The base 110 is configured to releasably mechanically and electrically couple with a light bulb (not shown). A light bulb can be placed within the recess formed on the front flange 112 side of the base 110. A watertight gasket may also be included in the recess to form a seal between the base 110 and a light bulb so as to prevent corrosion and electrical failure. The front flange 112 is shaped to provide support and protection to a light bulb. The body 114 is cylindrically shaped to conform to the general shape of a light bulb. The wire recesses 116 enable a wire to be coupled to either end of the base 110. In most light strings, the light bulbs are electrically coupled in series such that the wire providing electricity to one light holder is then routed to the next light holder. Various electrically coupling systems may be used and remain consistent with the present invention.

The trigger clip 120 provides a mechanism for releasably coupling the light holder to a surface. The trigger clip 120 is coupled to the base 110 via the attachment member 126. The attachment member 126 also acts as a compliant spring for use in releasably coupling the trigger clip 120. Initially, the light holder 100 is positioned near a structure for releasable attachment. A user must then depress or engage the trigger clip 120 by applying pressure to the finger rest 122 causing the clip portion 124 to retract away from the base 110. The attachment member 126 will provide a biasing force against the expansion of the clip portion 124. The light holder I 00 is then positioned such that the structure for attachment is between the clip portion 124 and the base 110. The finger rest 122 is then released and the biasing force of the attachment member 126 causes the clip portion 124 to releasably clamp over the structure. Various other releasable coupling systems may also be used and remain consistent with the present invention. Various shapes of finger rests, clip portions, and attachment members are contemplated by this invention.

Thus, as discussed herein, the embodiments of the present invention relate to a light bulb holder. More particularly, the present invention relates to a light bulb holder configured for releasably coupling to surfaces and objects. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A light holder for use on a light string comprising:
a base configured to mechanically and electrically couple with a light bulb;
at least one wire coupled to the base to provide electricity to the light bulb; and
a trigger clip coupled to the base, wherein the trigger clip is configured to releasably couple the light holder to a structure, and wherein the trigger clip includes a clip portion, a finger rest, and an attachment member.

2. The light holder of claim 1, wherein the base is substantially cylindrical and includes a recess conformed to coupling with the lightbulb.

3. The light holder of claim 1, wherein the base includes an integrated gasket.

4. The light holder of claim 1, wherein the at least one wire includes two wires on opposite sides of the base.

5. The light holder of claim 1, wherein the attachment member provides a spring bias for releasably coupling the light holder to the trigger clip.

6. The light holder of claim 1, wherein the trigger clip is coupled to the base between the clip portion and the finger rest.

7. The light holder of claim 6, wherein the clip portion is longer than the finger rest.

8. The light holder of claim 1, wherein the clip portion is curved to enable the reliable coupling to comprise hooking.

9. The light holder of claim 1, wherein the reliable coupling between the trigger clip and a structure includes releasable clamping.

10. A light string comprising:
an electrical receptacle configured to electrically coupled with a standard electrical outlet;
a plurality of light holders electrically coupled to the electrical receptacle, wherein each light holder comprises:
a base configured to mechanically and electrically couple with a light bulb;
at least one wire coupled to the base to provide electricity to the light bulb; and
a trigger clip coupled to the base, wherein the trigger clip is configured to releasably couple to a structure, and wherein the trigger clip includes a clip portion, a finger rest, and an attachment member.

11. The light string of claim 10, wherein the trigger clip is coupled to the base between the clip portion and the finger rest.

12. The light string of claim 11, wherein the clip portion is longer than the finger rest.

13. The light string of claim 10, wherein the clip portion is curved to enable the reliable coupling to comprise hooking.

14. The light string of claim 10, wherein the reliable coupling between the trigger clip and a structure includes releasable clamping.

15. A method of coupling a light holder to a structure comprising the acts of:
positioning the light holder adjacent to a structure; and
engaging a releasable coupling mechanism on the light holder to releasably couple the light holder to the structure; and
wherein the acts are all performed with a single hand.

16. The method of claim 15, wherein the act of positioning the light holder adjacent to a structure further includes:
locating a proper structure that will receive the light holder; and
aligning the light holder with the located structure.

17. The method of claim 15, wherein the act of engaging a releasable coupling mechanism on the light holder to releasably couple the light holder to the structure further includes:
depressing a finger rest on the light holder which causes a clip portion to expand;
disposing the clip portion over the structure; and
releasing the finger rest causing the clip portion to clamp over the structure.

18. The method of claim 15, wherein the light holder further includes:
a base configured to mechanically and electrically couple with a light bulb;
at least one wire coupled to the base to provide electricity to the light bulb; and
a trigger clip coupled to the base, wherein the trigger clip is configured to releasably couple to a structure, and wherein the trigger clip includes a clip portion, a finger rest, and an attachment member.

19. The method of claim 18, wherein the trigger clip is coupled to the base between the clip portion and the finger rest.

20. The method claim 19, wherein the clip portion is longer than the finger rest.
